(19) United States
(12) Patent Application Publication
(10) Pub. No.: US 2017/0032250 A1
(43) Pub. Date: Feb. 2, 2017

(54) Machine Status And User Behavior Analysis System

(71) Applicant: Ching-Ping Chang, Taipei City (TW)

(72) Inventor: Ching-Ping Chang, Taipei City (TW)

(21) Appl. No.: 14/811,845

(22) Filed: Jul. 29, 2015

(51) Int. Cl. G06N 5/02; G06N 99/00

(52) U.S. Cl. CPC G06N 5/022; G06N 99/005

(57) ABSTRACT

A machine status and user behavior analysis system includes a detection side device and an analysis side device. The detection side device is electrically connected with the machine. The detection side device includes a data retrieving module, a sensing module, and a data processing module. The data retrieving module retrieves internal data of the machine. The sensing module senses the status of the machine to obtain sensed data. The data processing module processes the internal data of the machine and the sensed data to classify the internal data of the machine and the sensed data into machine status data and operation condition data. The analysis side device is wirelessly connected with the detection side device to receive the machine status data and the operation condition data. The analysis side device includes a data recognizing module which recognizes the machine status data to find a machine abnormal status and recognizes the operation condition data to find user behavior.

### (a) TECHNICAL FIELD OF THE INVENTION

The present invention relates generally to an analysis system, and more particularly to a machine status and user behavior analysis system.

### (b) DESCRIPTION OF THE PRIOR ART

Now with advances in technology, a variety of machines give people a lot of convenience and have become indispensable tools in life.

Machine status, is not only related to manufacturing quality of the machine, but also related to operational behaviors of users. And it will have considerable impacts on the users, manufacturers and surrounding industry of the machine. A machine, which is used normally, maintained in health condition, and has good operating characteristics and reactions, not only reduces its maintenance cost, but also gives recognition to its manufacturers. And the surrounding industry can also be benefited through the widespread use of the machine.

However, heretofore, machine status or the operational behavior of user are not continuously being recorded or tracked after the machine has been being manufactured and then transported from the factory, so that the operating characteristics and responses under control of the machine, and also the effects on the costs and profits, are not easy to be assessed and controlled.

### SUMMARY OF THE INVENTION

The primary object of the present invention is to provide a machine status and user behavior analysis system, which comprises a detection side device and an analysis side device. The detection side device is electrically connected with the machine. The detection side device comprises a data retrieving module, a sensing module, and a data processing module. The data retrieving module retrieves internal data of the machine. The sensing module senses the status of the machine to obtain sensed data. The data processing module processes the internal data of the machine and the sensed data to classify the internal data of the machine and the sensed data into machine status data and operation condition data. The analysis side device is wirelessly connected with the detection side device to receive the machine status data and the operation condition data. The analysis side device comprises a data recognizing module which recognizes the machine status data to find a machine abnormal status and recognizes the operation condition data to find user behavior.

Preferably, the detection side device and the analysis side device are wirelessly connected with each other through a base station, the base station comprises a geographic position computing module computing geographic position data of the detection side device according to a geographic position of the base station and a transmit signal between the base station and the detection side device.

Preferably, the data processing module of the detection side device processes the internal data of the machine and the sensed data in a feature extracting manner.

Preferably, the analysis side device further receives the internal data of the machine and the sensed data through the detection side device and processes the internal data of the machine and the sensed data in a feature extracting manner by means of a processing module.

Preferably, the analysis side device comprises a pattern recognizing module recognizing a pattern of the internal data of the machine that have been processed in the feature extracting manner and/or a pattern of the sensed data that have been processed in the feature extracting manner to discover a data pattern model.

Preferably, the pattern recognizing module further extracts the machine status data, the operation condition data, and observation points, and the machine status data, the operation condition data, the observation points are sent back to a database of the analysis side device for having the data recognizing module recognizing the machine status data and the operation condition data.

Preferably, the analysis side device further comprises a learning module learning the discovered data pattern model to obtain user preference data and/or error diagnosis data.

Preferably, the analysis side device further comprises a predicting module acquiring machine error prediction result and/or a user behavior prediction result according to the machine abnormal status and/or the user behavior.

Preferably, the analysis side device further comprises an advising module providing user behavior advice and/or machine error and solution advice according to the machine error prediction result, the user behavior prediction result, the machine abnormal status, and/or the user behavior.

Preferably, it further comprises a user side device, the user side device is connected with the analysis side device through a network so as to receive data stored in the analysis side device.

Preferably, one of the detection side devices receives, in a wireless manner, data from a plurality of other detection side devices that have been processed by the analysis side device.

The present invention disclosed a detection side device that retrieves internal data of a machine and senses status of the machine, and processes and classifies them into machine status data and the operation condition data, and an analysis side device wirelessly connected therewith receives and further recognizes the machine status data and the operation condition data to find a machine abnormal status and user behavior. Therefore, after the machine has been being manufactured and then transported from the factory, the status of the machine and operational behavior of a user thereof can be continuously tracked and recorded in a remote manner. This helps the user understanding the influence on the machine due to the user's operational behavior much more, and provides advice regarding manufacture quality, management, and control to the manufacturers, and also provides benefit assessment regarding machine use to the surrounding industry. Further, the present invention can track the geographic position of the machine to prevent the machine from being lost or stolen and to prevent over stocking of the machine resulted from poor warehousing management.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view showing equipment involved in an embodiment of the present invention.

FIG. 2 is a schematic view showing system architecture of the embodiment of the present invention.

FIG. 3 is a schematic view showing an operation of a detection side device of the embodiment of the present invention.

FIG. 4 is a schematic view showing an operation of an analysis side device of the embodiment of the present invention.

FIG. 5 is a schematic view showing another operation of the analysis side device of the embodiment of the present invention.

FIG. 6 is a schematic view showing functional architecture of a user side device of the embodiment of the present invention.

FIG. 7 is a schematic view showing an acoustic fingerprint analysis operation in the analysis side device of the embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

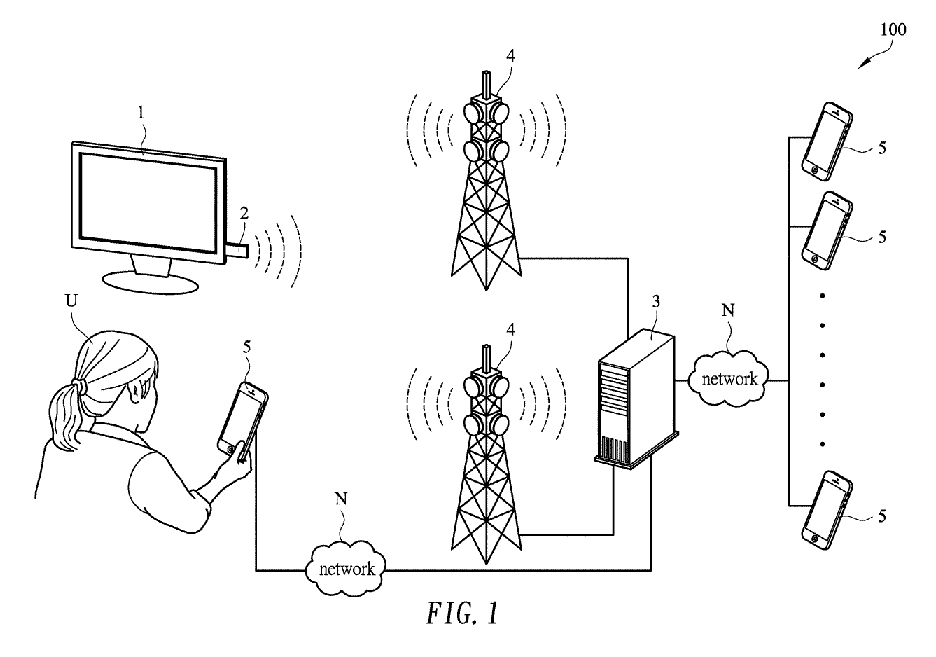

Referring to FIG. 1, the present invention provides a machine status and user behavior analysis system 100, which analyzes the status of a machine 1 and also analyzes operational behavior of a user U of the machine 1. In this embodiment, the machine 1 is a television set.

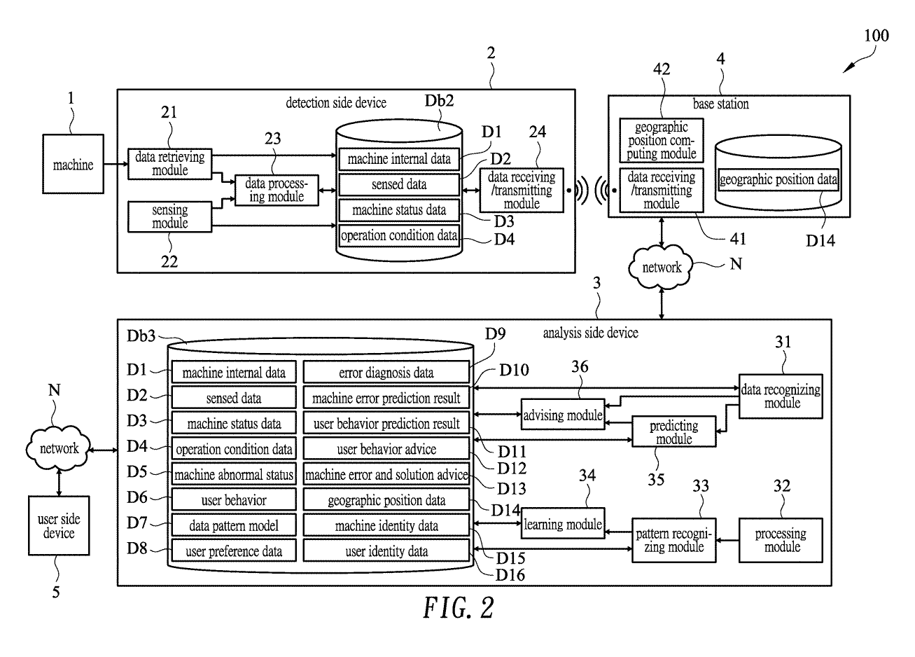

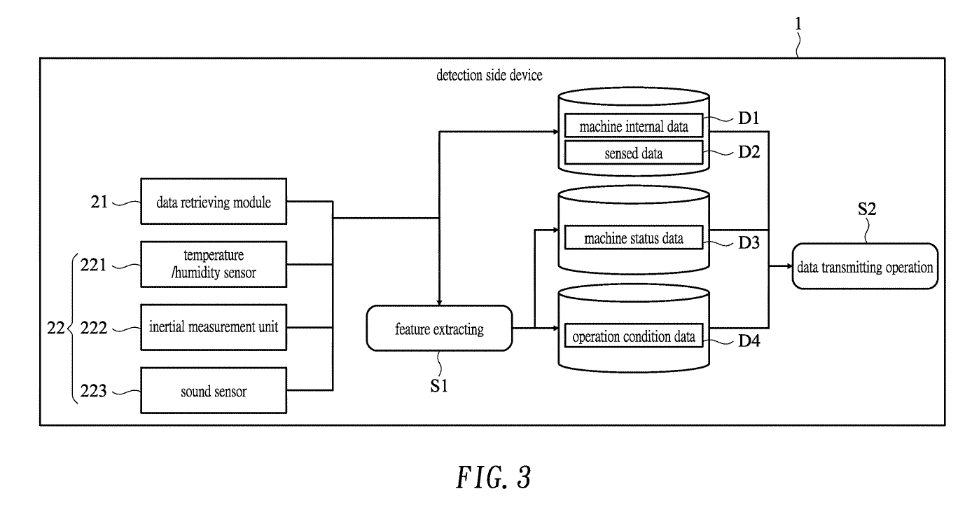

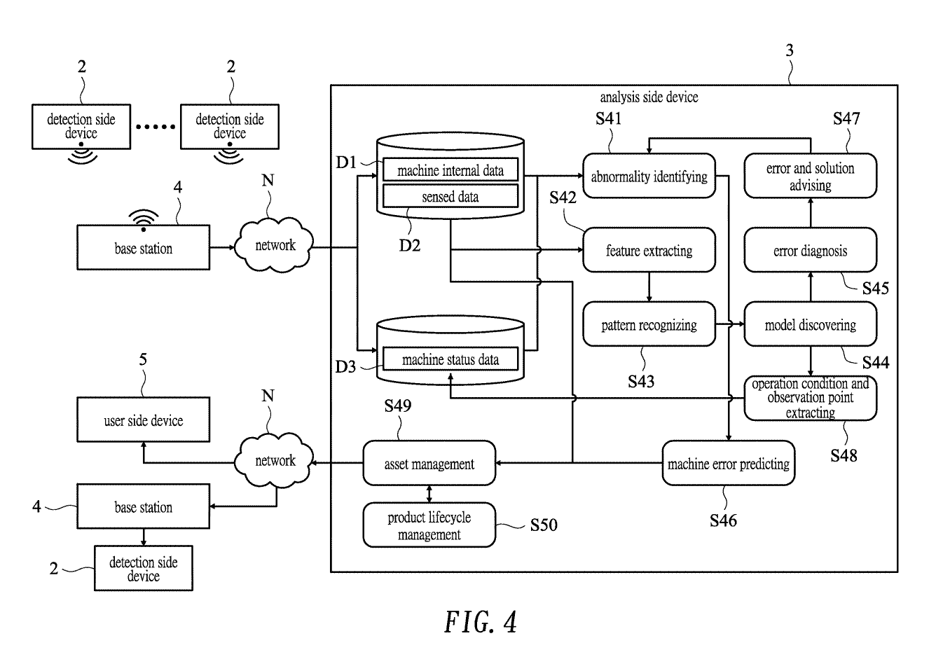

Referring collectively to FIGS. 1 and 2, as well as FIGS. 3-5, the machine status and user behavior analysis system 100 according to the present invention comprises a detection side device 2 and an analysis side device 3.

The detection side device 2 is electrically connected with the machine 1. In this embodiment, the detection side device 2 is inserted into a USB connection port of the machine 1 to read internal data of the machine. However, the present invention is not limited thereto. The detection side device 2 may be alternatively built in the machine 1, or further alternatively, the detection side device 2 may be set up at a location neighboring to the machine 1, such as being arranged to be opposite to the machine 1 in order to detect and to photograph the machine 1. The detection side device 2 can be provided with a battery in order to supply electricity for the operation of the detection side device 2. The detection side device 2 also can receive and consume electrical power from the machine 1 or other external power sources. Preferably, the detection side device 2 comprises a unique and specific identification code in order to provide machine identity data D15 of the machine 1 to the analysis side device 3. The detection side device 2 also comprises user identity inputting member in order to provide user identity data D16 of the machine 1 to the analysis side device 3.

The detection side device 2 comprises a data retrieving module 21, a sensing module 22, and a data processing module 23. The data retrieving module retrieves internal data of the machine D1, such as voltages. The sensing module 22 senses the status of the machine 1 to obtain sensed data D2. In this embodiment, the internal data of the machine D1 and the sensed data D2 are metering data. In this embodiment, the sensing module 22 comprises a temperature/humidity sensor 221, an inertial measurement unit (IMU) 222, and a sound sensor 223. The sensing module 22 also can comprise sensors and transducers of other types and functionalities. The data processing module 23 processes the internal data of the machine D1 and the sensed data D2 to classify the internal data of the machine D1 and the sensed data D2 into machine status data D3 and operation condition data D4. More specifically, the machine status data D3 comprises, for example, inherent operation characteristics of the machine 1 and status changes of the machine 1 caused by external factors. The operation condition data D4 comprises the machine performance caused by, for example, a normal user operation or an abnormal user operation. In this embodiment, the data processing module 23 processes the internal data of the machine D1 and the sensed data D2 in a feature extracting manner (Step S1) in order to establish the machine status data D3 and the operation condition data D4. The machine internal data D1, the sensed data D2, the machine status data D3, and the operation condition data D4 are stored in a database Db2 of the detection side device 2. In this embodiment, the detection side device 2 further comprises a data receiving/transmitting module 24, which executes a data transmitting operation (Step S2) to transmit, in a wireless manner, the machine internal data D1, the sensed data D2, the machine status data D3, and the operation condition data D4. In this embodiment, the data receiving/transmitting module 24 is an ultra high frequency (UHF) long range radio transceiver, which transmits data through an antenna.

In this embodiment, the detection side device 2 and the analysis side device 3 are wirelessly connected with each other through a base station 4. The base station 4 comprises a data receiving/transmitting module 41 in order to execute data transmission between the detection side device 2 and the base station 4 in a wireless manner and is connected with the analysis side device 3 through a network N to execute network data transmission. In a preferred embodiment, the base station 4 comprises a geographic position computing module 42 computing geographic position data D14 of the detection side device 2 according to a geographic position of the base station 4 and a transmit signal between the base station 4 and the detection side device 2 in order to track the geographic position of the machine 1 to prevent the machine 1 from being lost or stolen and to prevent over stock of the machine 1 resulted from poor warehousing management.

The analysis side device 3 receive the machine status data D3 and the operation condition data D4 and further, by means of a data recognizing module 31, recognizes the machine status data D3 to find a machine abnormal status D5 (Step S41) and recognizes the operation condition data D4 to find user behavior D6 (Step S51). However, the present invention is not limited thereto. The analysis side device 3 also can receive the machine internal data D1 and the sensed data D2 (namely the metering data) through the detection side device 2, and the data recognizing module 31 also can recognize the machine internal data D1 and the sensed data D2 to find the machine abnormal status D5 and the user behavior D6 (Step S41, S51).

In a preferred embodiment, the analysis side device 3 also can processes the internal data of the machine D1 and the sensed data D2 in a feature extracting manner by means of a processing module 32 (Step S42, S52). In a preferred embodiment, the analysis side device 3 comprises a pattern recognizing module 33 recognizing a pattern of the internal data of the machine D1 that have been processed in the feature extracting manner and/or a pattern of the sensed data D2 that have been processed in the feature extracting manner (Step S43, S53) in order to discover a data pattern model D7 (Step S44, S54). Preferably, the pattern recognizing module 33 further can extract the machine status data, the operation condition data, and observation points, and the machine status data, the operation condition data, the observation points are sent back to a database Db3 of the analysis side device 3 (Step S48, S58) for having the data recognizing module 31 recognizing the machine internal data D1, the sensed data D2, the machine status data D3, and the operation condition data D4.

In a preferred embodiment, the analysis side device 3 further comprises a learning module 34 learning the discovered data pattern D7 (Step S45, S55) so as to obtain user preference data D8 and/or error diagnosis data D9. Operation preference of a user can be found according to the user preference data D8; and a cause resulting in failure or error of the machine 1 can be found according to the error diagnosis data D9. In addition to the cause resulting in failure or error, the error diagnosis data D9 may further comprises a reasoning and diagnosis method obtained by means of the learning of the learning module 34. The user preference data D8 and the error diagnosis data D9 can also be further used for having the data recognizing module 31 recognizing the machine internal data D1, the sensed data D2, the machine status data D3, and the operation condition data D4 in order to find the machine abnormal status D5 and the user behavior D6.

In a preferred embodiment, the analysis side device 3 may further comprise a predicting module 35, acquiring machine error prediction result D10 and/or a user behavior prediction result D11 according to the machine abnormal status D5 and/or the user behavior D6 (Step S46, S56). In a preferred embodiment, after the machine error prediction result D10 has been acquired in Step S46, the asset management of the machine 1 may be executed (Step S49), such as predictive maintenance and product lifecycle management (Step S50) of the machine 1.

In a preferred embodiment, the analysis side device 3 may further comprise an advising module 36 providing user behavior advice D12 and/or machine error and solution advice D13 according to the machine error prediction result D10, the user behavior prediction result D11, the machine abnormal status D5, and/or the user behavior D6 (Step S47, S57). The machine error and solution advice D13 may comprise, for example, a possible error (failure) location and possible error occurrence time of the machine 1, a potential operation that causes the failure, and advice of troubleshooting solution for solving the error mentioned above.

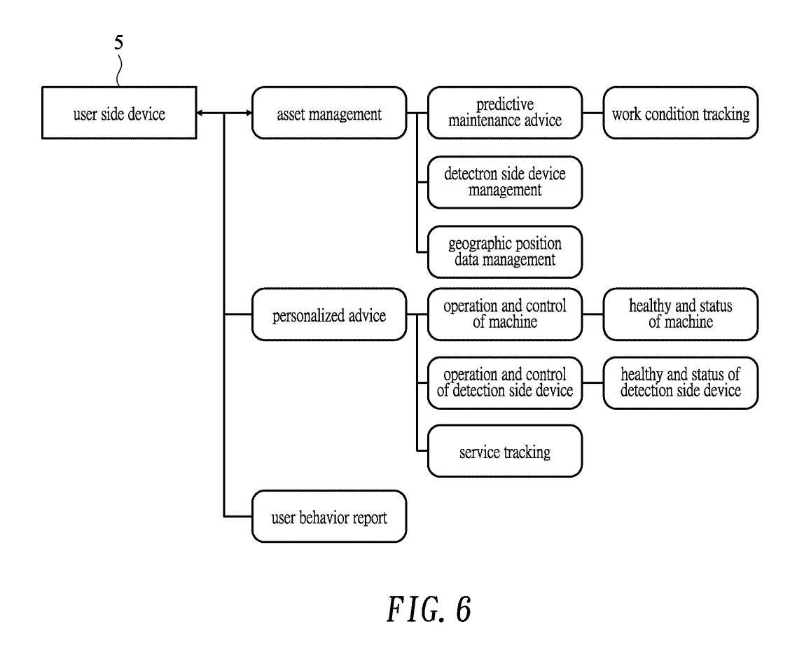

Referring collectively to FIGS. 1-5, in a preferred embodiment, the machine status and user behavior analysis system 100 further comprises a user side device 5, which is connected with the analysis side device 3 through the network N so as to receive data stored in the analysis side device 3, such as the machine status data D3, the operation condition data D4, the machine abnormal status D5, the user behavior D6, the user preference data D8, the error diagnosis data D9, the machine error prediction result D10, the user behavior prediction result D11, the user behavior advice D12, the machine error and solution advice D13, the geographic position data D14, the machine identity data D15, and the user identity data D16. Therefore, as shown in FIG. 6, the user U (such as a machine manufacturer, a user of the machine, and a surrounding industry of the machine) can use the user side device 5 to execute asset management of the machine 1, including predictive maintenance advice, work condition tracking (such as work order tracking), and geographic position data management. The user U also can use the user side device 5 to execute asset management of the detection side device 2. Further, the user side device 5 also can generate personal advice, including advice regarding operation and control of the machine 1 or those of the detection side device 2, advice regarding healthy and status of the machine 1 or those of the detection side device 2, service tracking (such as client service order tracking) of the machine 1 or that of the detection side device 2, as a reference for the user U. Of course, the user side device 5 also can generate an operational behavior report of the user U regarding the machine 1.

Referring collectively to FIGS. 2, 4, and 5, preferably, a single detection side device 2 can further be used to receive data that are from a plurality of other detection side devices 2 and have been processed by the analysis side device 3. The data, which is related to a plurality of machines 1 and is stored in the analysis side device 3, particularly the machine status data D3 and the operation condition data D4 related to a plurality of machines 1, can be transmitted to individual ones of the detection side devices 2 through the network N and the base station 4 in a wireless manner, so that a single detection side device 2 can receives, in a wireless manner, data processed by the analysis side device 3 from a plurality of other detection side devices 2, as a reference for the data processing module 23. Therefore, a detection side device 2 also can learn data processing experience of the analysis side device 3 and that of a plurality of other detection side devices 2, such as feature extracting experience and data recognizing experience, so that each of the detection side devices 2 may get smarter through learning and provide better data processing result.

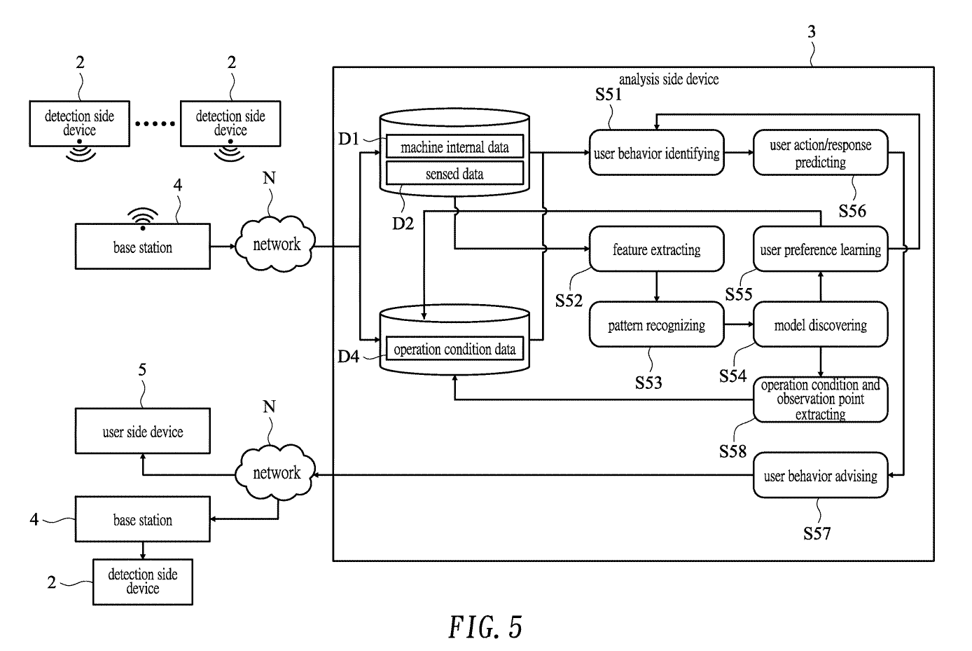

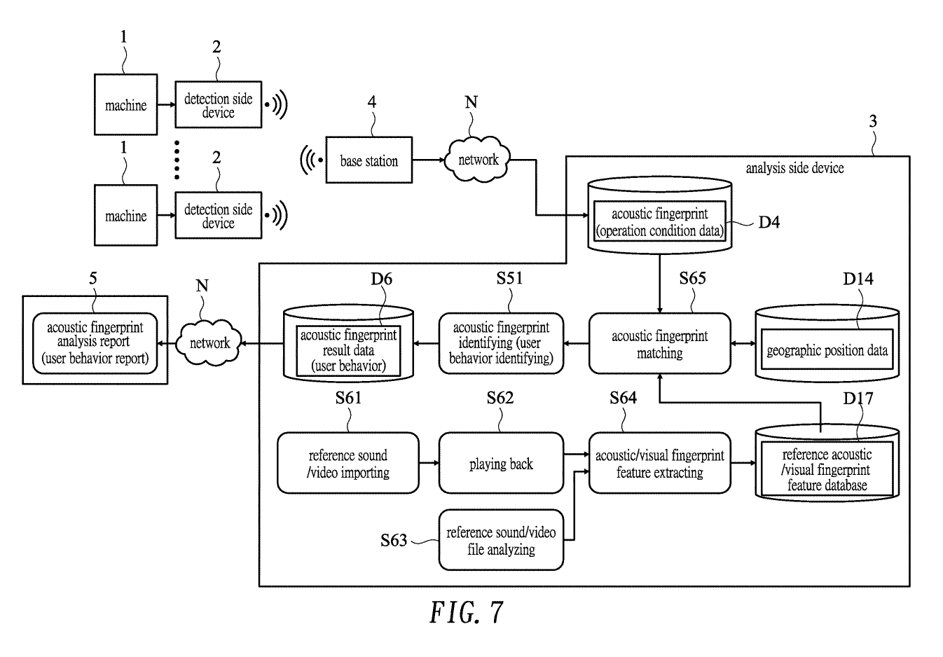

Referring to FIG. 7, in combination with FIG. 5, for example, while a surrounding industry (such as a television channel provider) of a machine 1 (such as a television set) is intending to get aware of user behavior (such as audience measurement), the television channel supplier firstly may input reference sounds/videos of programs broadcasted by each of the television channels into the analysis side device 3 (Step S61) and make them being played (Step S62), or acquire the reference sounds/videos by analyzing files of the reference sounds/videos Step S63). And then, fingerprint feature of sounds/videos is extracted (Step S64) and is stored as reference acoustic/visual fingerprint feature database D17. When the analysis side device 3 obtains, through the network N, the base station 4, and the detection side device 2, acoustic fingerprint (namely the operation condition data D4) of a sound form the machine 1, which is sensed by the sound sensor 223 (FIG. 3) and then is processed by the detection side device 2, the analysis side device 3 can execute fingerprint matching (Step S65) that matches the acoustic fingerprint (namely the operation condition data D4) with reference acoustic/visual fingerprint feature database D17 to execute acoustic fingerprint recognizing (namely Step S51, user behavior identifying), so as to obtain acoustic fingerprint result data (namely the user behavior D6), and thus the television channel on the machine 1 that the user is watching is found out. Further, the user side device 5 also can generate acoustic fingerprint analysis report (or visual fingerprint analysis report) based on the acoustic fingerprint result data (or visual fingerprint result data) (namely the user behavior D6) for having the television channel supplier investigating and statistically analyzing the audience measurement. Furthermore, the acoustic fingerprint analysis report and the visual fingerprint analysis report also can be combined with the geographic position data D14, so that the television channel supplier can realize the correlation between audience measurement and geographic position.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A machine status and user behavior analysis system, which is adapted to analyze a status of a machine and to analyze operational behavior of a user of the machine, the machine status and user behavior analysis system comprising:
a detection side device, which is electrically connected with the machine, the detection side device comprising a data retrieving module, a sensing module, and a data processing module, the data retrieving module retrieving internal data of the machine, the sensing module sensing the status of the machine to obtain sensed data, the data processing module processing the internal data of the machine and the sensed data to classify the internal data of the machine and the sensed data into machine status data and operation condition data; and
an analysis side device, which is wirelessly connected with the detection side device to receive the machine status data and the operation condition data, the analysis side device comprising a data recognizing module which recognizes the machine status data to find a machine abnormal status and recognizes the operation condition data to find user behavior.

2. The machine status and user behavior analysis system according to claim 1, wherein the detection side device and the analysis side device are wirelessly connected with each other through a base station, the base station comprises a geographic position computing module computing geographic position data of the detection side device according to a geographic position of the base station and a transmit signal between the base station and the detection side device.

3. The machine status and user behavior analysis system according to claim 1, wherein the data processing module of the detection side device processes the internal data of the machine and the sensed data in a feature extracting manner.

4. The machine status and user behavior analysis system according to claim 1, wherein the analysis side device further receives the internal data of the machine and the sensed data through the detection side device and processes the internal data of the machine and the sensed data in a feature extracting manner by means of a processing module.

5. The machine status and user behavior analysis system according to claim 3, wherein the analysis side device comprises a pattern recognizing module recognizing a pattern of the internal data of the machine that have been processed in the feature extracting manner and/or a pattern of the sensed data that have been processed in the feature extracting manner to discover a data pattern model.

6. The machine status and user behavior analysis system according to claim 5, wherein the pattern recognizing module further extracts the machine status data, the operation condition data, and observation points, and the machine status data, the operation condition data, the observation points are sent back to a database of the analysis side device for having the data recognizing module recognizing the machine status data and the operation condition data.

7. The machine status and user behavior analysis system according to claim 5, wherein the analysis side device further comprises a learning module learning the discovered data pattern model to obtain user preference data and/or error diagnosis data.

8. The machine status and user behavior analysis system according to claim 1, wherein the analysis side device further comprises a predicting module acquiring machine error prediction result and/or a user behavior prediction result according to the machine abnormal status and/or the user behavior.

9. The machine status and user behavior analysis system according to claim 8, wherein the analysis side device further comprises an advising module providing user behavior advice and/or machine error and solution advice according to the machine error prediction result, the user behavior prediction result, the machine abnormal status, and/or the user behavior.

10. The machine status and user behavior analysis system according to claim 1, further comprising a user side device, the user side device being connected with the analysis side device through a network so as to receive data stored in the analysis side device.

11. The machine status and user behavior analysis system according to claim 1, wherein one of the detection side devices receives, in a wireless manner, data from a plurality of other detection side devices that have been processed by the analysis side device.

12. The machine status and user behavior analysis system according to claim 4, wherein the analysis side device comprises a pattern recognizing module recognizing a pattern of the internal data of the machine that have been processed in the feature extracting manner and/or a pattern of the sensed data that have been processed in the feature extracting manner to discover a data pattern model.

13. The machine status and user behavior analysis system according to claim 12, wherein the pattern recognizing module further extracts the machine status data, the operation condition data, and observation points, and the machine status data, the operation condition data, the observation points are sent back to a database of the analysis side device for having the data recognizing module recognizing the machine status data and the operation condition data.

14. The machine status and user behavior analysis system according to claim 12, wherein the analysis side device further comprises a learning module learning the discovered data pattern model to obtain user preference data and/or error diagnosis data.
